(19) United States
(12) Patent Application Publication
(10) Pub. No.: US 2005/0241694 A1
(43) Pub. Date: Nov. 3, 2005

(54) HOT TAPPING METHOD, SYSTEM AND APPARATUS

(75) Inventor: Jared Sayers, Red Deer (CA)

Correspondence Address: SEAN W. GOODWIN, 237- 8TH AVE. S.E., SUITE 360, THE BURNS BUILDING, CALGARY, AB, T2G 5C3, CA

(73) Assignee: RED FLAME HOT TAP SERVICES LTD., Red Deer (CA)

(21) Appl. No.: 10/908,105

(22) Filed: Apr. 27, 2005

Related U.S. Application Data
(60) Provisional application No. 60/566,098, filed on Apr. 29, 2004.

(51) Int. Cl. B23B 41/08

(52) U.S. Cl. 137/318

(57) ABSTRACT

In one aspect of the invention there is provided a system for hot tapping, comprising a hot tap machine, a hole saw, a riser pipe, a blow out preventor capable of reducing its inside diameter, a valve sealably connectable between the riser pipe and the blow out preventor, a tubular extension sealably connectable between the blow out preventor and the hot tap machine, and at least one extension rod having a lock-out shoulder with a diameter greater than the blow out preventor's reduced inside diameter. Apparatus and method aspects are also provided.

### CROSS REFERENCE TO RELATED APPLICATION

This application is a regular application of U.S. Provisional Patent Application Ser. No. 60/566,098 filed Apr. 29, 2004 and entitled, “NOVEL HOT TAPPING METHOD, SYSTEM AND APPARATUS”, the entirety of which is incorporated herein by reference.

### FIELD OF THE INVENTION

The present invention relates generally to a method, system and apparatus for hot tapping a branch line onto a main pipeline and, more particularly, to a method, system and apparatus for hot tapping an extended reach riser branch line onto a main pipeline.

### BACKGROUND OF THE INVENTION

In the oil and gas industry, hot taps are used when repairing a defective area of a pipeline or plant piping without taking it out of service; by setting up a temporary bypass line to provide a path for fluid flow while the defect is repaired. Hot taps may also be used to install a new branch line or a permanent bypass line; again without taking the main pipeline or the plant piping out of service. In either case a valve will be placed on the new line (i.e. branch line or bypass line) as part of the hot tap procedure. After operations, the valve may remain in place, e.g. functioning as a control valve for a branch line, or be removed when the temporary bypass line is removed.

In hot tapping operations it is desirable to eliminate the need to bury a branch line's valve below ground—as has been the traditional practice with buried pipelines. One disadvantage of a buried valve is that it does not allow for quick access.

### SUMMARY OF THE INVENTION

In one aspect of the invention there is provided a system for hot tapping, the system comprising: a hot tap machine having a shaft; a hole saw; a riser pipe; a blow out preventor capable of reducing its inside diameter to a closing diameter; a valve sealably connectable between the riser pipe and the blow out preventor; a tubular extension a tubular extension sealably connectable between the blow out preventor and the hot tap machine; and at least one extension rod, having a lock-out shoulder with a diameter greater than the closing diameter.

In another aspect of the invention there is provided an apparatus for use in a hot tapping operation, the hot tapping operation employing a hot tap machine and a hole saw and being conducted through a blow out preventor, the blow out preventor capable of reducing its inside diameter, the apparatus comprising: an extension rod having a lock-out shoulder with a diameter greater than the blow out preventor's reduced diameter.

In yet another aspect of the invention there is provided an apparatus for use in a hot tapping operation, the hot tapping operation employing an extension rod having a main rod portion and a lock-out shoulder, said lock-out shoulder having a diameter greater than said main rod portion, the apparatus comprising: a blow out preventor capable of reducing its inside diameter to a closing diameter so as to sealably engage said main rod portion.

In yet another aspect of the invention there is provided a method for use in a hot tapping operation of a main pipe, the hot tapping operation employing a hot tap machine, the hot tap machine having a shaft, and a hole saw assembly and being conducted through a tubular extension, a blow out preventor, the blow out preventor capable of reducing its inside diameter to a closing diameter, and further employing a plurality of interconnectable extension rods each having a lock-out shoulder with a diameter greater than the closing diameter and each suitable for connecting between the shaft of the hot tap machine, another extension rod or the hole saw, the method comprising the steps of: attaching a first end of a riser pipe to the main pipe; mounting a valve to a second end of the riser pipe;

connecting a sufficient number of interconnectable extension rods to the hole saw assembly so as to form an extending assembly and so as to enable hot tapping operations with the extending assembly to proceed through the riser pipe, the valve, the blow out preventor and the tubular extension when all are mounted together; inserting the extending assembly into the valve and riser pipe; mounting the blow out preventor over the extending assembly and to the valve; mounting the tubular extension of the extending assembly and to the blow out preventor; mounting the shaft of the hot tap machine to the extending assembly; mounting the hot tap machine to the tubular extension; drilling through the main pipe with the hot tap machine and extending assembly; closing the blow out preventor on a main rod portion of one of the extensions rods in the extending assembly; tripping out the extending assembly, rod-by-rod back through the riser pipe, the valve, the blow out preventor and tubular extension, so as to ensure that for each rod the lock-out shoulder interacts with the blow out preventor, wherein each interaction of the lock-out shoulder with the blow out preventor provides a positive lock.

In another embodiment of this method aspect, and where the diameter of the hole saw assembly is sufficiently small to pass through the blow out preventor, the blow out preventor is mounted to the valve and lubricator extension is mounted to the blow out preventor prior to inserting the extending assembly.

### BRIEF DESCRIPTION OF THE DRAWINGS

FIG. 1a is a side view of one embodiment of a system of hot tapping wherein the valve is situated above ground level;

FIG. 1b is an exploded perspective view of some of the components of the embodiment of FIG. 1;

FIG. 1c is a perspective view of a riser pipe of a preferred embodiment welded to a nipple on a main pipe;

FIG. 2a is a perspective view of a preferred embodiment of a bundle of interconnectable extension rods;

FIG. 2b is a perspective view of a preferred embodiment of a blow out preventor;

FIG. 2c is a perspective view of a preferred embodiment of a tubular member extension or lubricator extension;

FIG. 2d is a perspective view of a preferred embodiment of a flange adapter spool;

FIG. 3 is a sectional side view of an interconnectable extension rod of the embodiment of FIG. 2a;

FIGS. 4a-4d are top, end, sectional (of line A-A in FIG. 4a) and perspective views of the extension rod sub portion or component of the embodiment of FIG. 2a;

FIGS. 5a-5c are side, perspective and top views of the extension rod main rod portion or component of the embodiment of FIG. 2a;

FIGS. 6a-6c are perspective, side and end views of a tubular member extension of the embodiment of FIG. 2c;

FIGS. 6d is a perspective view of a tubular member extension of the embodiment of FIG. 2c attached to a hot tap machine;

FIGS. 6e is a perspective view of a tubular member extension of the embodiment of FIG. 2c with the shaft of a hot tap machine protruding through it.

FIG. 7a is a top view of a preferred embodiment of a extension rod fork;

FIG. 7b is a perspective view of the extension rod fork of the embodiment of FIG. 7a; the fork is shown inserted onto an extension rod and resting on the top of a blow out preventor so to suspend the extension rod assembly above a main pipe (not shown);

FIG. 8 is a perspective view of the embodiment of FIG. 1a;

FIG. 9 is a perspective view of a hydrostatic pressure testing device mounted on a valve of the branch connection;

FIGS. 10-15 are a perspective views of the embodiment of FIG. 1a;

FIG. 16 is a perspective view of a hole saw assembly, suitable for use with the embodiment of FIG. 1a;

FIG. 17 is a perspective view of an interconnectable extension rod of the embodiment of FIG. 2a;

FIG. 18 is a perspective view of a trip socket suitable for use with the embodiment of FIG. 1a;

FIGS. 19 is a perspective view of a tubular member extension of the embodiment of FIG. 2c;

FIG. 20 is a perspective view of the embodiment of FIG. 1a showing an extension rod protruding through the blow out preventor and connected to the shaft of a hot tap machine which is protruding through the lubricator extension, the extension rod, lubricator extension and hot tap machine held in place by a rod fork slid onto the extension rod;

FIGS. 21-23 are perspective views of the embodiment of FIG. 1a.

### DETAILED DESCRIPTION OF THE PREFERRED EMBODIMENTS

Reference is to be had to the Figures in which identical reference numbers identify similar components.

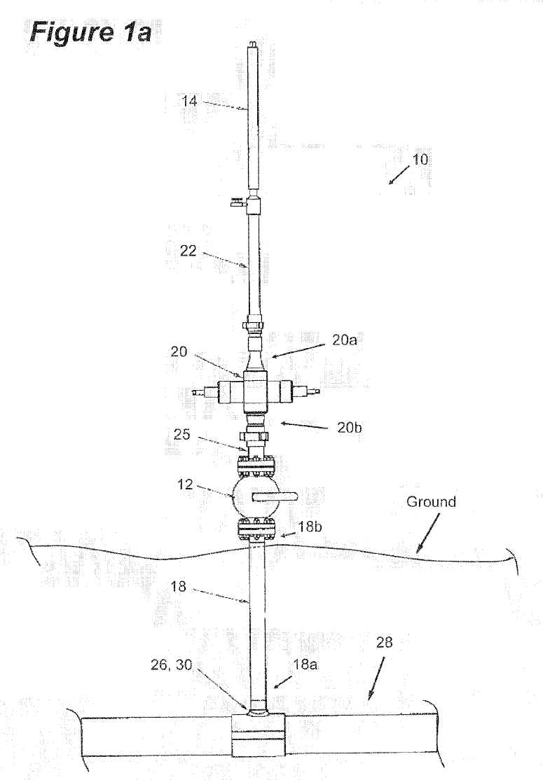

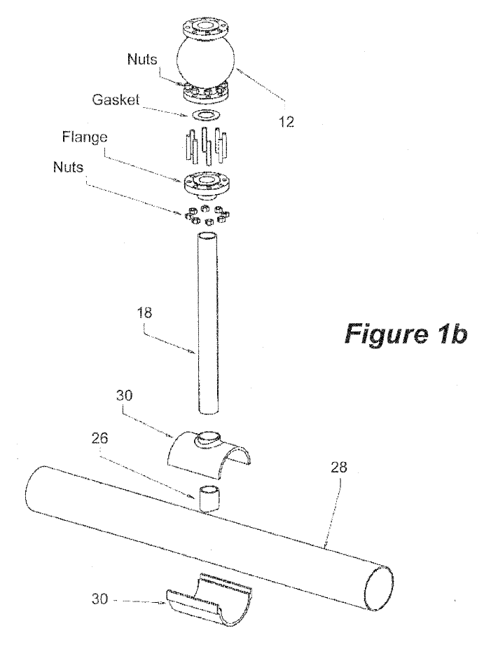

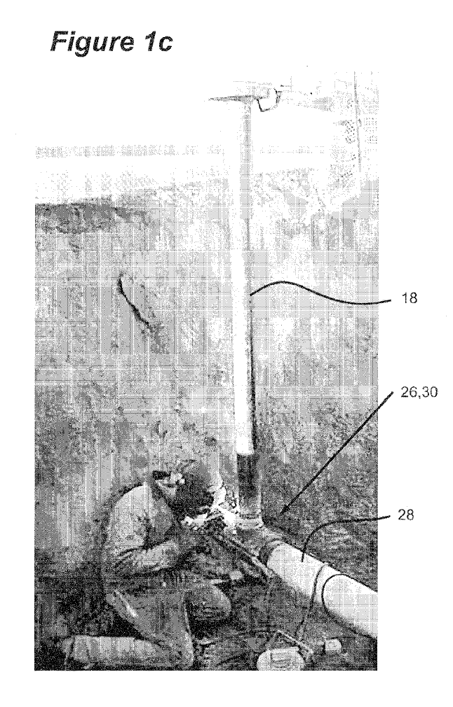

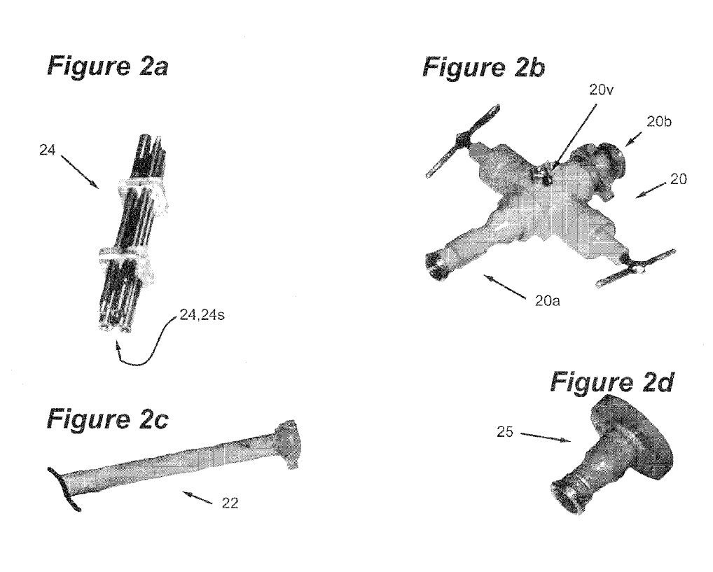

Referring to FIGS. 1a -6c, 8, 10-14, and 17 a preferred embodiment of a novel system of hot tapping 10 wherein a valve 12 is positioned above ground is shown. The system comprises: a hot tap machine 14, a hole saw or hole saw assembly 16, a riser pipe 18, a valve 12, a blow out preventor 20, a tubular extension, also called a lubricator extension, 22 and a plurality of extension rods 24.

The hot tap machine 14, hole saw 16 and valve 12 can be conventional equipment. The hot tap machine 14 is sealably connectable to the tubular extension 22. The tubular extension 22 is sealably connectable to the blow out preventor 20. The blow out preventor 20 is sealably connectable to the valve 12. Preferably, a flange adapter spool 25 facilitates the sealable connection between the blow out preventor 20 and valve 12 (See FIG. 1a). The valve 12 is sealably connectable to the riser pipe 18. Preferably, the riser pipe 18 is suitable for welding to a nozzle or nipple 26 which in turn is welded to the main pipe 28. Preferably, a split-tee assemble 30 is mounted around the main pipe 28 and nipple 26 by means of welds. A suitable valve 12 is a full port ball valve or a full port gate valve.

Preferably, the riser pipe 18 has a first end 18a suitable for welding to the nipple 26 (FIGS. 1a-1c). Preferably the riser pipe 18 is flanged at a second end 18b; Typical lengths of riser pipe 18 range from six feet to sixteen feet.

The blow out preventor 20 has means for reducing its inside diameter to a smaller closing diameter. Preferably such means comprise a pair of internal rams. A suitable blow out preventor 20 may be constructed by modifying a manual valve wireline blow out preventor, such as the Seal-o-matic™ blow out preventor sold by Vanoil Equipment Inc. of Red Deer, Alberta, Canada. The manual valve wireline blow out preventor is modified so as to enlarge the closing diameter of its rams (when compared to a typical off-the-shelf 1/4″ closing diameter which is generally suitable only for wireline applications), thereby enabling it to seal against a larger diameter rod 24, or other device,. In the preferred embodiment the enlargement is to a closing diameter of 1⅛″.

Preferably the blow out preventor 20 further comprises adapter portions 20a, 20b tapering so as to assist in sealably connecting the blow out preventor to the lubricator extension 22 and the flange adapter spool 25. Advantageously, said adapter portions 20a, 20b minimize the need for threaded adapters and treaded connections, thereby minimizing potential leakage sites. More preferably, said adapter portions 20a, 20b are solid machined portions. A blow out preventor 20 having one pair of rams is generally sufficient. A blow out preventor 20 with multiple pairs of rams will work as well.

The tubular or lubricator extension 22 functions as a receiver for each of the extension rods 24 during the hot tapping operation. In the preferred embodiment, the lubricator extension 22 is 28 inches in length. In another embodiment (not show) the lubricator extension 22 is 30 inches in length.

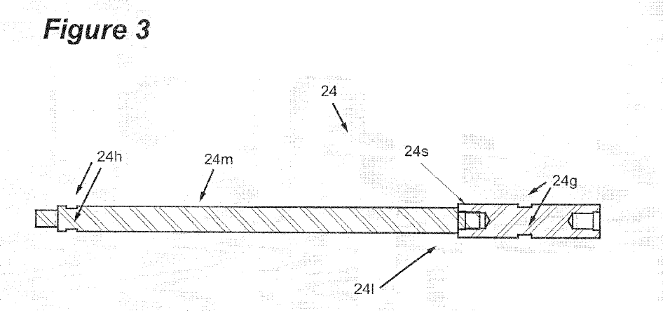

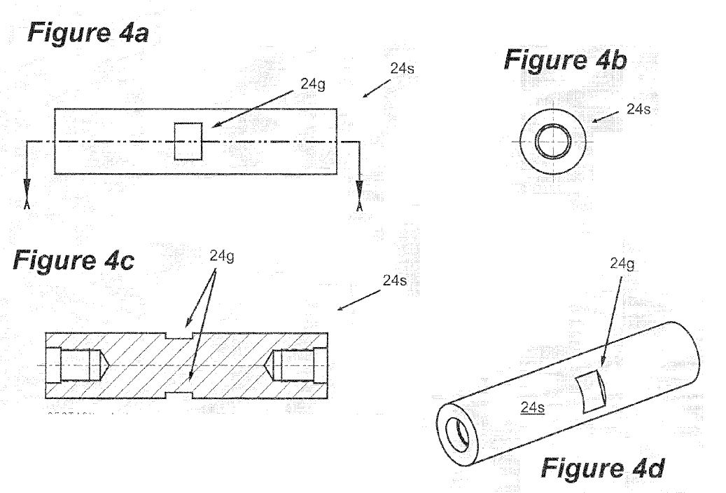

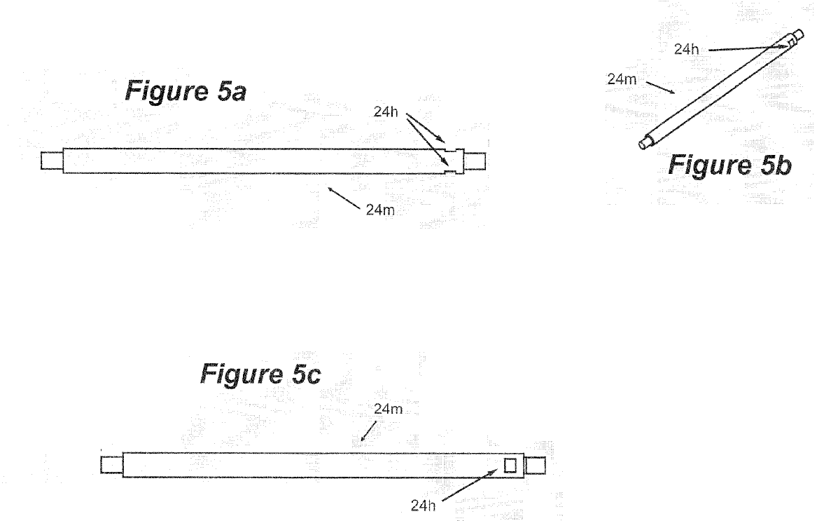

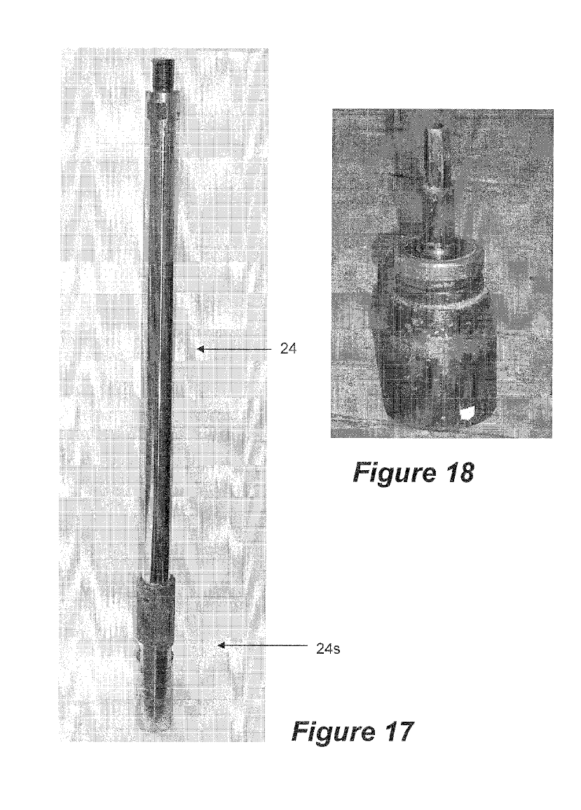

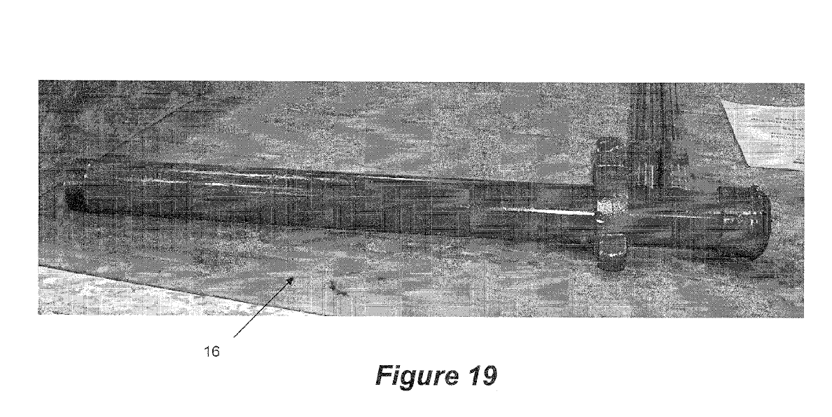

Each of the extension rods 24 has a lock-out shoulder 24l with a diameter greater than the closing diameter of the blow out preventor 20. The series of interconnectable extension rods 24 attach between the hole saw 16 and the hot tap machine 14. The extension rods 24 function to extend the reach of the hot tap machine 14 and hole saw 16, thereby enabling hot tap operations through a riser pipe 18. In the preferred embodiment each extension rod 24 comprises a main rod portion 24m having a first diameter and a sub portion 24s having a second and larger diameter, so as to form a lock-out shoulder 24l at the interface of the main rod 24m and sub 24s portions (see FIGS. 3 and 17). In an alternative embodiment (not shown) a lock-out shoulder may be machined out of a continuous section of rod.

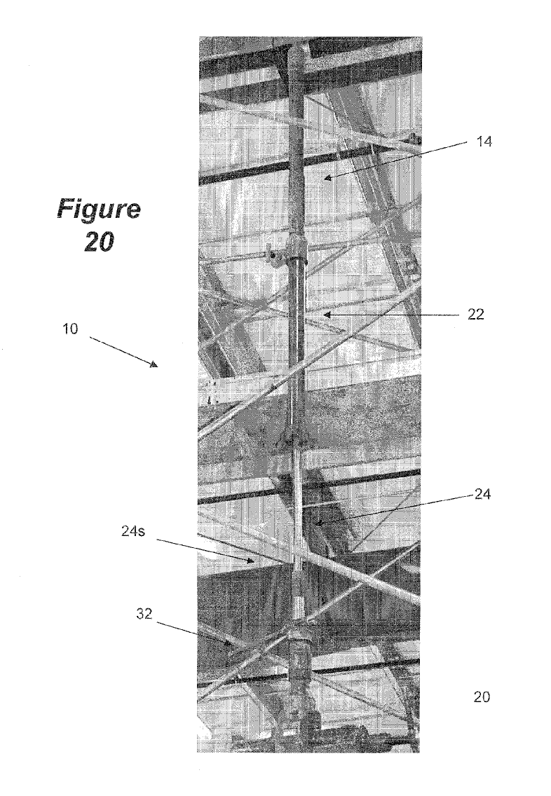

In the preferred embodiment the diameter of the main rod portion 24m is 1⅛ inches and the diameter of the sub portion 24s, is 1½ inches. Also in the preferred embodiment, each extension rod 24 is 25 inches long; the sub portion 24s being 4 inches long and the main rod portion 24m being 21 inches long. Preferably, the extension rod 24 has at least one pair of parallel grooves or wrench flats 24g running perpendicular to the longitudinal axis of the rod 24, the grooves 24g being oriented so as to be capable of receiving a fork 32 (see FIGS. 7b and 20). More preferably, the extension rod 24 has a first pair of parallel grooves 24g on the sub portion and a second pair of grooves 24h on that end of the main rod portion distally located from the sub portion 24s (see FIG. 3). Advantageously, in operation a fork 32 can insert onto an extension rod 24 and rest on the top of a blow out preventor 20, so as to suspend an extension rod 24 assembly above the main pipe 28 (see FIGS. 7b and 20) or so as to suspend an extension rod 24, or rod 24 assembly and hole saw 16, and prevent it from falling down the blow out preventor 20, valve 12 and riser pipe 18.

Preferably, the extension rod 24 has a polished surface. More preferably the rod's 24 outside surface is created through a chrome induction process. Advantageously, such a polished surface creates a good seal when engaged by the rams of the blow out preventor 20.

Method:

Referring to the Figures, a preferred embodiment of a method aspect of the invention is typically used after the mounting of conventional hot tap components to a main pipe 28. The conventional hot tap components comprises a branch nozzle or nipple 26 (shown in FIG. 1b) welded to the main pipe 28, and a reinforcement split tee assembly 30 (or full encirclement saddle, not shown) clamped over the nipple 26 and main pipe 28 and subsequently welded longitudinally at both seams and circumferentially to the nipple 26.

The preferred embodiment of the method comprises the following steps:

Welding the first end 18a of the riser pipe 18 to the branch nipple 26 (FIG. 1c). The riser pipe 18 being sufficiently long to bring its second end 18b above ground level. Preferably the second end 18b is flanged.

Mounting a valve 12 to the riser pipe's second end 18b. Advantageously, the mounted valve 12 will therefore be above ground level and can thus be easily accessed to control flow.

Determining the number of extension rods 24 that will be required to enable hot tapping operations to proceed through riser pipe 18, valve 12 , blow out preventor 20 and lubricator extension 22. Preferably this determination is done by measuring from the main pipe's 28 outside diameter up through the riser pipe 18 to the upper valve flange of the lubricator extension 22. More preferably, this measurement will ensure that the last extension rod extends at least 6 inches out of the lubricator extension 22, and hence 6 inches into the hot tap machine 14 so as to provide an adequate stroke when operating the hot tap machine 14.

Assembling the appropriate amount of extension rods 24 as required.

Attaching a hole saw or hole saw assembly 16 (see FIG. 16) to the assembled extension rods 24.

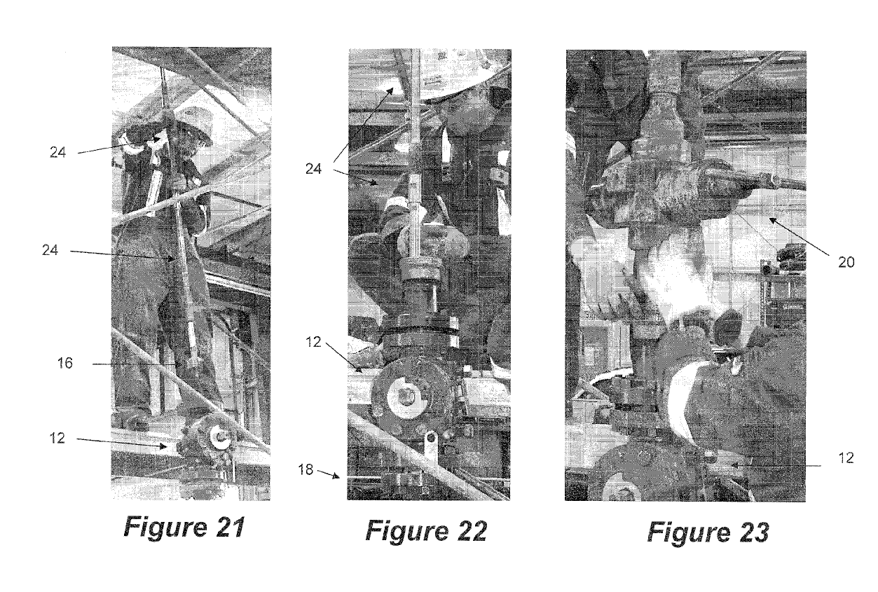

Passing this entire assembly (hole saw assembly 16 and interconnected extension rods 24) through the valve 12 and riser pipe 18 and just to the main line pipe's 28 outside diameter (see FIG. 21). Preferably, not resting thee bit of the hole saw 16 (at the end of the interconnected extension rods) on the main line pipe 28 but holding the entire assembly so that the hole saw's bit is suspended above the pipe 28 (see FIG. 22). More preferably the entire assembly is held using a rod fork 32 (FIG. 7a).

Mounting a blow out preventor 20 over the entire assembly, as it is held suspended above the pipe 28, and to the valve 12 (see FIG. 23). More preferably the blow out preventor 20 is mounted by means of a flange adaptor spool 25. More preferably ensuring that the blow out preventor 20 is in the open position.

Mounting a tubular extension 22 over the entire assembly, as it is held suspended above the pipe 28, and to the blow out preventor 20.

Advantageously, the blow out preventor 20 and lubricator extension 22 are mounted over the entire assembly (rods 24 and hole saw 16) so as to allow the use of a 4 inch diameter hole saw bit—the blow out preventor 20 of the preferred embodiment having a maximum inside diameter of only 3 inches and thus incapable of allowing a 4 inch diameter hole saw, and hence the entire assembly, to pass through it. Advantageously, by not allowing the entire assembly of rods 24 and hole saw 16 to pass, additional safety elements are created, should the gas pressure attempt to force out the entire assembly. Note however, that with a maximum inside diameter of 3 inches, the preferred embodiment of the blow out preventor 20 is still able to be mounted over the interconnected extension rods 24, including the sub portions 24s.

Closing the blow out preventor 20 to hold the rods 24 and assembly in place.

Preferably, attaching a 2 inch extension rod (not shown) to the hot tap machine shaft 14s. Advantageously, the 2 inch extension is to act as an adaptor or interface between the hot tap machine shaft 14s and the extension rods 24. Since during the extraction of the extension rods 24 the break will be made between these rods 24 and the small extension interface rather than causing unnecessary wear to the threads of the hot tap machine shaft 14s.

Preferably applying an anti seize thread compound, such as Jet-Lube™ No. 60 thread compound, to the threaded end of the lubricator extension 22 which attaches to the hot tap machine 14.

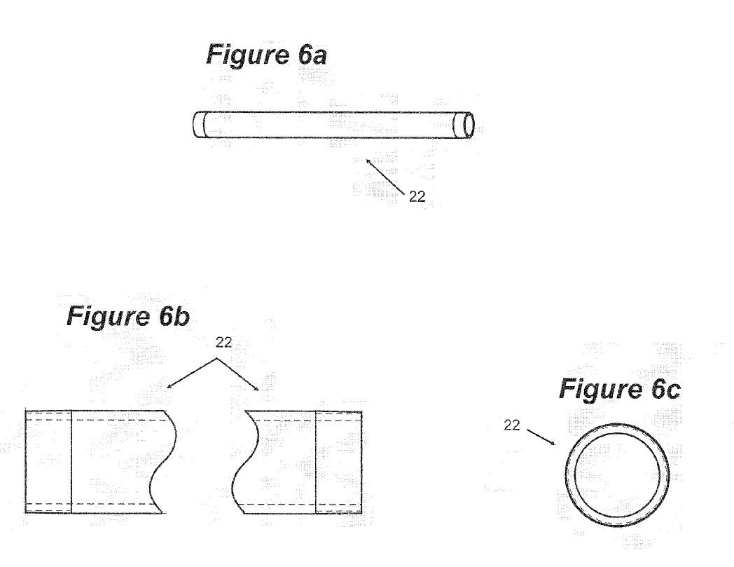

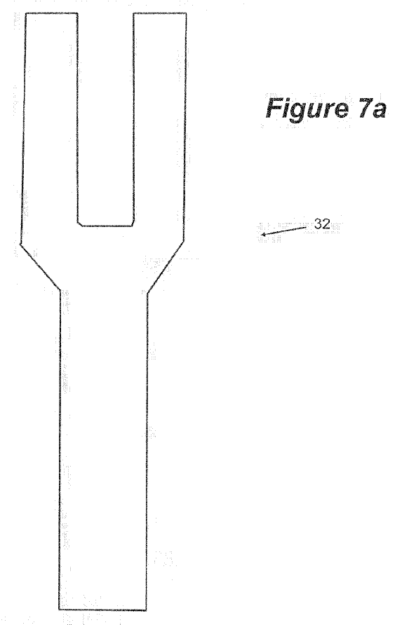

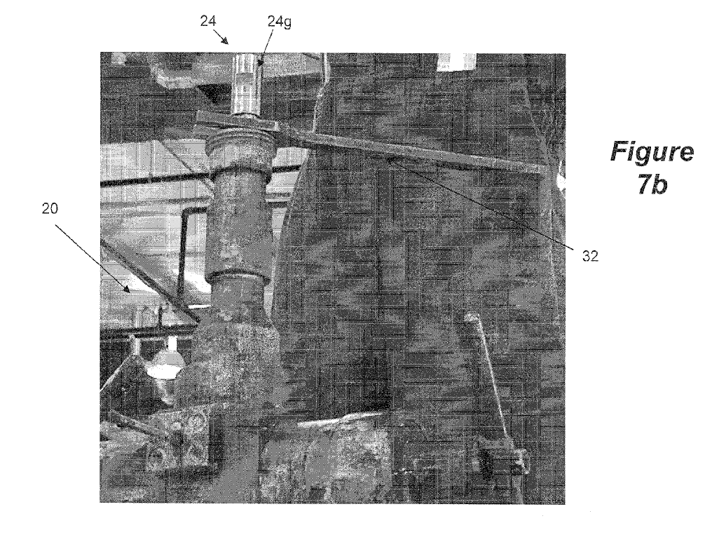

Extending the hot tap machine shaft 14s so that the 2 inch extension, or the shaft 14s without an extension, protrudes through the lubricator extension 22 (see FIG. 6e).

Attaching the shaft 14s of the hot tap machine 14, or the 2 inch extension, to the extension rod 24 protruding from the blow out preventor 20 and sealing the hot tap machine 14 to the lubricator extension 22. Preferably turn the shaft 14s from the top of hot tap machine 14 using a ratchet crank.

Connecting and sealing the lubricator extension 22 to the blow out preventor 20. Preferably this connection is a hammerlock connection.

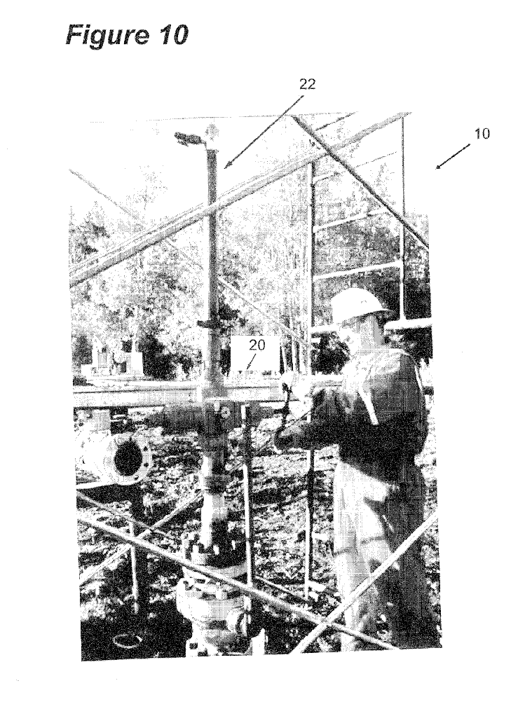

Opening the blow out preventor 20 (FIG. 10).

Drilling through the main pipe 28. Preferably as follows:

Manually extending the hot tap machine 14 to make contact with the pipe 28. Then retract the hole saw 16 bit a few turns to stand it off from the pipe 28.

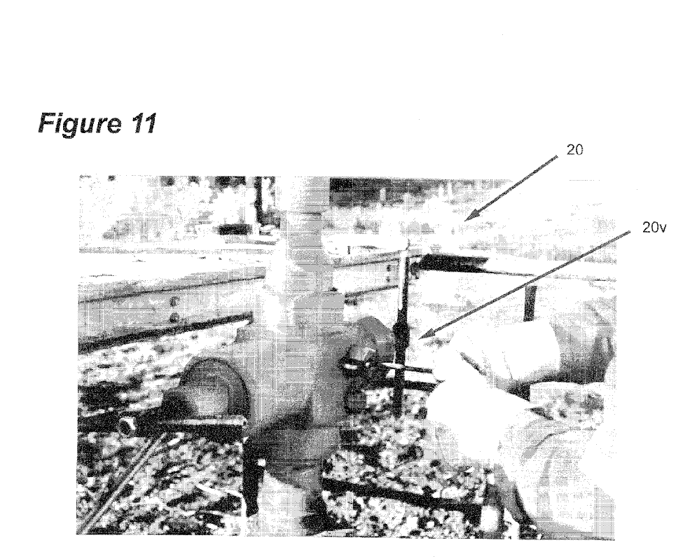

Closing a bleeder valve on hot tap machine 14 and an equalizer valve 20v on the blow out preventor 20 (see FIG. 11) .

Coupling an air drill to the hot tap machine 14.

Using the air drill, start the drilling operation and assert a slow steady feed to the outer casing to advance a pilot bit into the pipe's material.

Discontinue drilling.

Extending the hot tap machine 14 manually until the hole saw 16 makes contact with the pipe 28.

Retracting the hot tap machine 14, preferably one full turn, to lift the hole saw 16 away from pipe 28.

Continue drilling.

Slowly extending the hot tap machine 14 until it drills through the main pipe 28 with the hole saw 18.

Stopping the drilling.

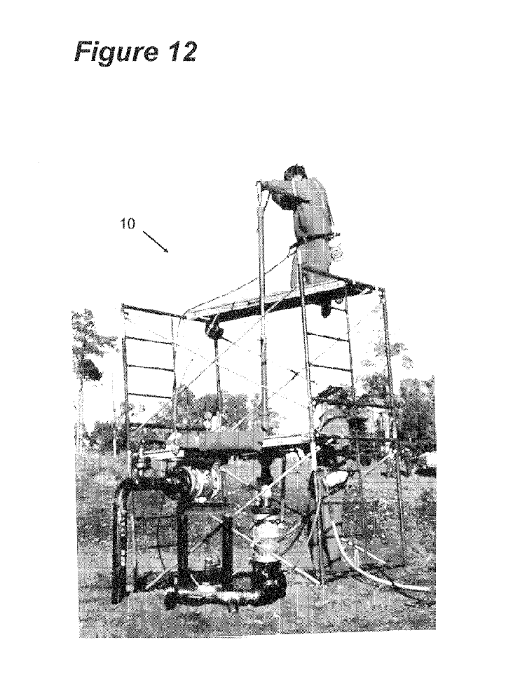

Reversing the hot tap machine 14 to bring the hot tap machine's shaft 14s up the measured column just about all the way back to the top of the machine, preferably to the 2 inch increment mark on the hot tap machine 14 (see FIG. 12). This assists in ensuring that the blow out preventor 20 closes on the main rod portion 24m of the rod extension 24 rather than on the sub portion 24s. In the preferred embodiment, the rod sub 24s contacts the blow out preventor 20 when the hot tap machine 14 is at about the ½ inch increment mark; therefore bringing it up to the 2 inch mark, then closing the blow out preventor 20 results in the machine's 14 shaft still having to trip back up about 1½ inches before the sub portion contacts the blow out preventor 20, advantageously creating a positive lock.

Extracting, or tripping out, the assembly of hole saw 18 and rods 24, rod-by-rod, back through the riser pipe 18, valve 12, blow out preventor 20 and lubricator extension 22, preferably the lock-out shoulder 24s of each rod 24 interacting with the blow out preventor 20 or its rams so as to provide a positive lock for each rod 24 extraction, as follows:

a) Closing the blow out preventor 20 and opening the bleeder valve on hot tap machine 14 to release trapped gas.

b) Breaking joint between lubricator extension 22 and blow out preventor 20.

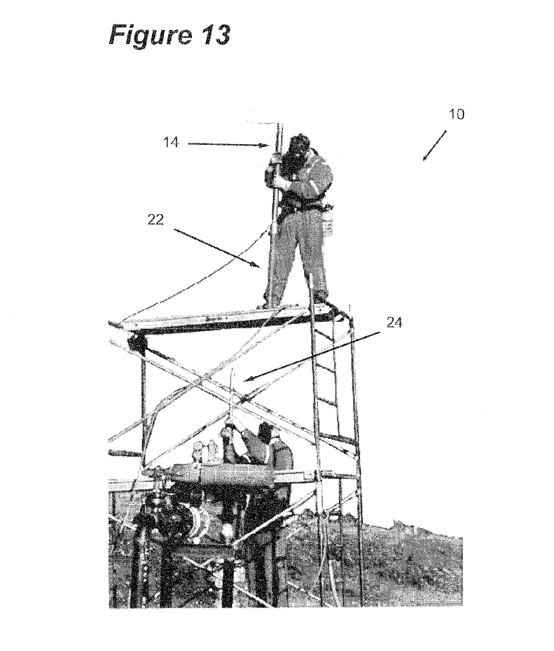

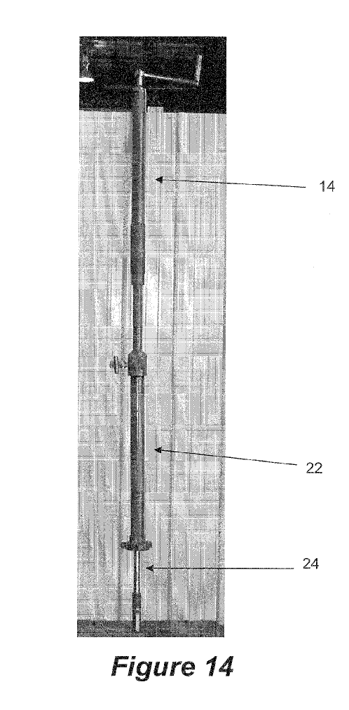

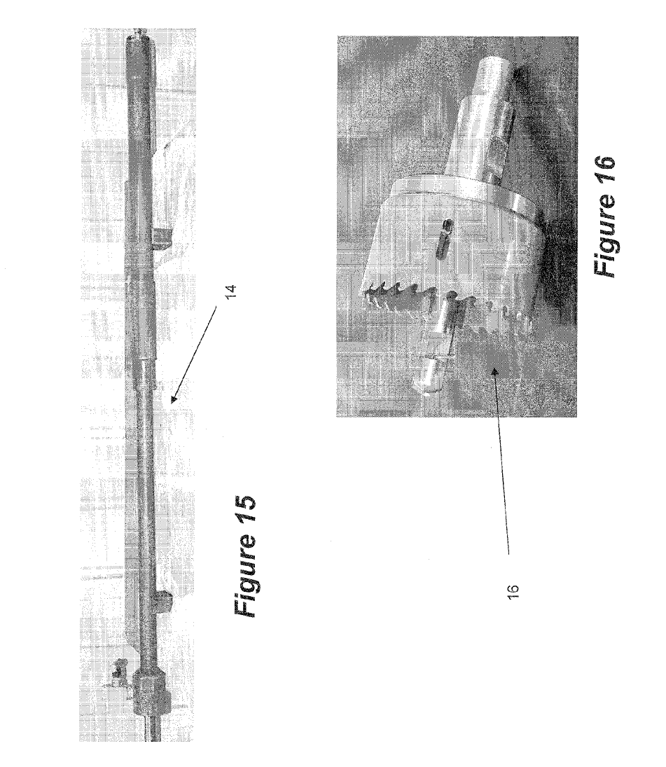

c) Running the hot tap machine spindle back down so as to cause the lubricator extension 22 to rise up the extension rod's 24 shaft thereby exposing the joint between the hot tap machine shaft 14s and extension rod's 24 shaft. Using appropriate wrenches break and unscrew this joint allowing hot tap machine 14 to be lifted to one side (see FIG. 13).

d) Unscrewing the next joint, between the assembled extension shafts 24, allowing an extension rod 24 to removed.

e) Lifting hot tap machine 14 back over the blow out preventor 20 and connect hot tap machine's shaft 14s to the next extension rod's 24 shaft in the blow out preventor 20 Run the spindle back up to close the gap between lubricator extension 22 and blow out preventor 20. Tighten the joint between the lubricator extension 22 and blow out preventor 20.

f) Opening the equalizer valve 20v to equalize the pressure on either side of the blow out preventor 20 and then close the valve 20v.

g) Opening blow out preventor 20.

h) Retracting hot tap machine spindle and

i) Repeating steps a) through h) for each of the remaining extension rods 24, so as to extract them all.

When the last extension rod 24 has cleared the valve 12, closing the valve 12.

Bleeding off entrapped gas from bleeder valve on hot tap machine 14, making sure blow out preventor 20 is open.

Removing hot tap machine 14, lubricator extension 22 and blow out preventor 20.

Preferably, secure a properly rated blind flange and gasket to the valve's 12 opening as required.

Preferably, retaining the cut coupon in the hole saw 16 and retrieving the coupon from the catchers on the hole saw bit.

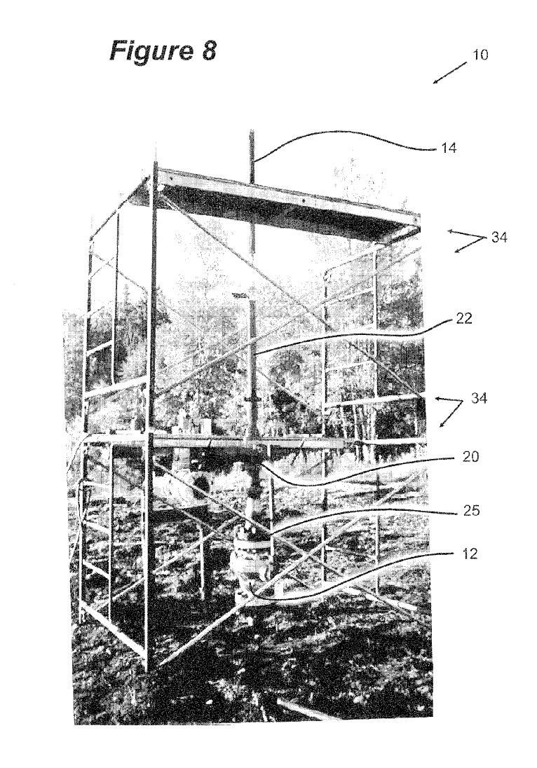

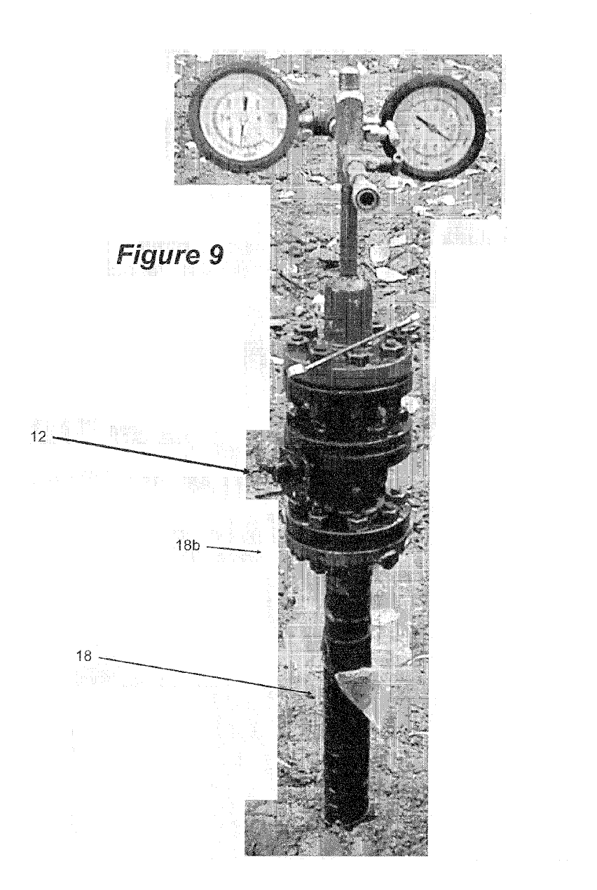

Preferably, the method further comprises erecting scaffolding 34 at least two tiers high (FIG. 8) to encompass and allow access to assembled valve 12 and riser pipe 18 prior to mounting the lubricator extension 22 on the blow out preventor 20. More preferably the method further comprises, performing hydrostatic pressure tests on the branch connection and valve 12 prior to mounting the blow out preventor 20 on the riser pipe 18 (see FIG. 9).

1. A system for hot tapping, the system comprising:
a hot tap machine;
a hole saw;
a riser pipe;
a blow out preventor capable of reducing its inside diameter;
a valve sealably connectable between the riser pipe and the blow out preventor;
a tubular extension sealably connectable between the blow out preventor and the hot tap machine; and
at least one extension rod having a lock-out shoulder with a diameter greater than the blow out preventor's reduced inside diameter.

2. The system of claim 1 wherein the lock-out shoulder of the extension rod is formed by a sub portion.

3. The system of claim 1 further comprising a pair of parallel grooves on said extension rod capable of receiving a rod fork.

4. The system of claim 1 wherein the extension rod has a polished surface.

5. The system of claim 4 wherein the polished surface is created through a chrome induction process.

6. An apparatus for use in a hot tapping operation, the hot tapping operation being conducted through a blow out preventor, the blow out preventor capable of reducing its inside diameter, the apparatus comprising:
an extension rod having a lock-out shoulder with a diameter greater than the blow out preventor's reduced inside diameter.

7. The apparatus of claim 6 wherein the lock-out shoulder is formed by a sub portion.

8. The apparatus of claim 6 further comprising a pair of parallel grooves capable of receiving a rod fork.

9. The apparatus of claim 6 wherein the rod has a polished surface.

10. The apparatus of claim 9 wherein the polished surface is created through a chrome induction process.

11. An apparatus for use in a hot tapping operation, the hot tapping operation employing an extension rod having a main rod portion and a lock-out shoulder, said lock-out shoulder having a diameter greater than said main rod portion, the apparatus comprising:
a blow out preventor capable of reducing its inside diameter to a closing diameter so as to sealably engage said main rod portion.

12. The apparatus of claim 11 wherein the blow out preventor further comprises an adapter portion tapering so as to assist in sealably connecting the blow out preventor to a tubular extension.

13. The apparatus of claim 11 wherein the blow out preventor further comprises an adapter portion tapering so as to assist in sealably connecting the blow out preventor to a flange adapter spool.

14. The apparatus of claim 12 wherein the blow out preventor further comprises a second adapter portion tapering so as to assist in sealably connecting the blow out preventor to a flange adapter spool.

15. The apparatus of claim 11 wherein the blow out preventor further comprises at least one pair of internal rams.

16. The apparatus of claim 11 wherein the lock out shoulder and blow out preventor are capable of interacting so as to create a positive lock.

17. The apparatus of claim 14 wherein the lock out shoulder and said pair of rams are capable of interacting so as to create a positive lock.

18. A method for use in a hot tapping operation of a main pipe, the hot tapping operation employing a hot tap machine, the hot tap machine having a shaft, and a hole saw assembly and being conducted through a tubular extension, a blow out preventor, the blow out preventor capable of reducing its inside diameter to a closing diameter, and further employing a plurality of interconnectable extension rods each having a lock-out shoulder with a diameter greater than the closing diameter and each suitable for connecting between the shaft of the hot tap machine, another extension rod or the hole saw, the method comprising the steps of:
attaching a first end of a riser pipe to the main pipe;
mounting a valve to a second end of the riser pipe;
connecting a sufficient number of interconnectable extension rods to the hole saw assembly so as to form an extending assembly and so as to enable hot tapping operations with the extending assembly to proceed through the riser pipe, the valve, the blow out preventor and the tubular extension when all are mounted together;
inserting the extending assembly into the valve and riser pipe;
mounting the blow out preventor over the extending assembly and to the valve;
mounting the tubular extension of the extending assembly and to the blow out preventor;
mounting the shaft of the hot tap machine to the extending assembly;
mounting the hot tap machine to the tubular extension;
drilling through the main pipe with the hot tap machine and extending assembly;
closing the blow out preventor on a main rod portion of one of the extensions rods in the extending assembly;
tripping out the extending assembly, rod-by-rod back through the riser pipe, the valve, the blow out preventor and tubular extension, so as to ensure that for each rod the lock-out shoulder interacts with the blow out preventor,
wherein each interaction of the lock-out shoulder with the blow out preventor provides a positive lock.
